(19) United States
(12) Patent Application Publication
(10) Pub. No.: US 2004/0089357 A1
(43) Pub. Date: May 13, 2004

(54) Integrated electrofluidic system and method

(76) Inventors: Christopher Dube, Lexington, MA (US); Jason O. Fiering, Cambridge, MA (US); Mark J. Mescher, West Newton, MA (US)

Correspondence Address: IANDIORIO & TESKA, INTELLECTUAL PROPERTY LAW ATTORNEYS, 260 BEAR HILL ROAD, WALTHAM, MA, 02451-1018, US

(21) Appl. No.: 10/601,606

(22) Filed: Jun. 23, 2003

Related U.S. Application Data
(60) Provisional application No. 60/390,773, filed on Jun. 21, 2002.

(51) Int. Cl. F16K 27/00

(52) U.S. Cl. 137/884

(57) ABSTRACT

An integrated electrofluidic system including an electronic control system amounted on a support platform, a microfluidic system embedded in the platform and having an input and an output and at least one electrofluidic component, and at least one electrical conductor carried by the platform for electrically interconnecting the electronic control system and the at least one electrofluidic component.

### RELATED APPLICATIONS

This application claims priority of U.S. Provisional Application Serial No. 60/390,773 filed on Jun. 21, 2002.

### FIELD OF THE INVENTION

This invention relates to a system and method for integrating and embedding electronic and microfluidic devices.

### BACKGROUND OF THE INVENTION

Microsystems often integrate microfluidic components such as channels, pumps, valves, and the like with electronic components for use in numerous applications, such as DNA analysis, drug delivery, detection of chemicals, analytes and biomolecules, tissue engineering, environmental sampling, and microdispensing.

Typical conventional microsystems integrate individual microfluidic and electronic components by first assembling the components on a common substrate and then interconnecting the fluidic components to the other components of the system with an interface such as microtubules. Manufacture of these prior art microsystems requires multiple placement steps of the various components on the substrate, dispensing of adhesive to attach the components to the substrate, and using discrete wires to electrically interconnect the various components. Moreover, these conventional microsystems typically employ silicon and glass materials because they can easily be precisely machined.

As shown above, these prior art microsystems suffer from several distinct disadvantages. Interconnecting the individual microfluidic and electronic components with delicate microtubules is time consuming, expensive, and unreliable. Moreover, as the number of components of the system increases, so does the amount of microtubules utilized which increases the total system volume of fluid thereby increasing the size of samples required for analysis. Increased fluid volume also results in a decrease in the performance due to longer system response time, functionality and reliability of the micro system. The requirement of multiple placement steps of the microfluidic and electronic components on the substrate and using discrete wires to interconnect the various components complicates the manufacturing processes, decreases reliability, and increases costs. Moreover, silicon and glass materials are more expensive than other readily available materials, such as polymers.

### SUMMARY OF THE INVENTION

It is therefore an object of this invention to provide an integrated electrofluidic system.

It is a further object of this invention to provide such an integrated electrofluidic system which eliminates the need for microtubules to interconnect individual fluidic and electronic components.

It is a further object of this invention to provide such an integrated electrofluidic system which is easy and inexpensive to manufacture.

It is a further object of this invention to provide such an integrated electrofluidic system which is reliable.

It is a further object of this invention to provide such an integrated electrofluidic system which eliminates the requirement for dispensing adhesives in order to integrate the fluidic and the electronic components of the system.

It is further object of this invention to provide such an integrated electrofluidic system which minimizes or eliminates the need to use discrete wires to electrically interconnect the fluidic and electronic components.

It is a further object of this invention to provide such an integrated electrofluidic system which eliminates multiple placement steps of the microfluidic and electronic components on the surface of substrate in order to integrate the various components of the system.

It is a further object of this invention to provide such an integrated electrofluidic system which utilizes polymer materials.

It is a further object of this invention to provide such an integrated electrofluidic system which requires much less volume of the sample fluid.

The invention results from the realization that a truly innovative integrated electrofluidic system can be achieved, not by attaching numerous individual fluidic and electronic components on the surface of a common substrate and then interconnecting the components with microtubules, but instead by utilizing a commercially available, low cost polymer material with a thin layer of adhesive which is machined and processed to define microfluidic and/or electronic components directly on the polymer material; additional layers of the polymer/adhesive material are added and additional microfluidic and/or electronic components may be defined; the layers are then laminated with the thin layer of adhesive which efficiently seals and bonds the layers; the result is that the microfluidic and/or electronic components are embedded within the system; the system also incorporates an electrical conductor which is embedded between the layers to provide an interconnection between the electronic components and the microfluidic components.

This invention features an integrated electrofluidic system including an electronic control system mounted on a support platform, a microfluidic system embedded in the platform and having an input and an output and at least one electrofluidic component, and at least one electrical conductor carried by the platform for electrically interconnecting the electronic control system and the at least one electrofluidic component.

In a preferred embodiment, the platform may include a plurality of laminated layers forming the embedded microfluidic system. The platform may include a polyimide material. The platform may include KAPTON®. The layers may be laminated using a phenolic resin adhesive. The phenolic resin adhesive may be R/FLEX®. The phenolic resin adhesive may be etched to a thickness of 3 to 10 μm. The phenolic resin adhesive may be selectively removed from regions where bonding is undesirable between the layers and/or between a layer and an electrofluidic and/or a microfluidic component. The microfluidic system may include a valve, a pump, a reservoir, a mixer, at least one channel, a filter, a dispenser, a reactor, a heater, a concentrator, a pressurizing device or a cooling device. A sensor device may be integrated with the microfluidic system. The sensor device may be embedded in the platform. The sensor device may include a flexure plate wave sensor. The sensor device may include an photoelectric sensor device, an optical sensor device, electrochemical sensor device, a temperature sensor device, a pressure sensor device, a flow sensor device, a viscosity sensor device, a mass sensor device, a magnetic sensor device, or an acoustic sensor device. A dispenser device may be integrated with the microfluidic system. A heat exchange device may be integrated with the microfluidic system. The dispenser device may include a drug delivery device. A fuel cell device maybe integrated with the output of the microfluidic system.

This invention also features an integrated electrofluidic system including an electronic control system mounted on a support platform, a microfluidic system embedded in the platform and having an input and an output and at least one electrofluidic component, at least one electrical conductor carried by the platform for electrically interconnecting the electronic control system and the at least one electrofluidic component, and a sensor integrated with the electrofluidic system.

In one embodiment, the platform may include a plurality of laminated layers forming the embedded microfluidic system.

This invention further features an integrated electrofluidic system including an electronic control system mounted on a support platform, a microfluidic system embedded in the platform and having an input and an output and at least one electrofluidic component, at least one electrical conductor carried by the platform for electrically interconnecting the electronic control system and the at least one electrofluidic component, and a dispenser device integrated with the electrofluidic system.

In one design, the platform may include a plurality of laminated layers forming the embedded microfluidic system. The dispensing device may dispense fluid in the range of about 100 microliters to 100 picoliters. The dispensing device may dispense fluid at a rate of about 0.1 to 100 microliters/min.

This invention further features an integrated electrofluidic system including an electronic control system mounted on a support platform, a microfluidic system embedded in the platform and having an input and an output and at least one electrofluidic component, at least one electrical conductor carried by the platform for electrically interconnecting the electronic control system and the at least one electrofluidic component, and a heat exchange device integrated with the electrofluidic system.

In one example, the platform may include a plurality of laminated layers forming the embedded microfluidic system.

This invention further features a method for manufacturing an integrated electrofluidic system, the method including the steps of a) providing a substrate layer having an adhesive layer, b) thinning the adhesive layer, c) machining the adhesive layer and the substrate layer to create features that define at least one microfluidic component and/or at least one electronic component, d) aligning the substrate layers, e) laminating the layers to embed the microfluidic component and/or the electronic component between the layers; and f) repeating steps a) through e) for a predetermined number of layers of the substrate and the adhesive layer.

In a preferred embodiment, the substrate layer may be KAPTON®. The adhesive layer may be thinned by plasma etching. The adhesive layer and the substrate may be machined by applying an energy beam. Step a) may further include providing additional microfluidic component and/or an electronic component to be embedded between the layers. The method of manufacturing an integrated electrofluidic system of this invention may further include the step of attaching additional microfluidic components and/or electronic components to the top surface of the laminated layers. The method of manufacturing an integrated electrofluidic system of this invention may include the step of applying a mask to the adhesive layer to define removal of the adhesive and to further define the microfluidic components. Step a) may further include providing electrical pads and electrical leads for interconnecting the microfluidic components and the electronic components. The method of manufacturing an integrated electrofluidic system of this invention may include the step of attaching electrical pads and electrical leads to the surface of the laminated layers. The machining may include raster scanning to define the features. The raster scanning step may include controlling the depth of the features by modifying the raster path. The method of manufacturing an integrated electrofluidic system of this invention may include the step of removing residual carbon and cleaning the substrate layers and tacking the layers. The machining may include depositing and patterning thin films of material on the substrate layer to form the electronic components. The material may be chosen from the group consisting of titanium, chrome, gold, platinum, tungsten, copper and nickel. The materials may be plated with a material which includes copper. A thin film of the material may be deposited on the substrate layer to form an electric heater. A thin film of the material may be deposited on the substrate layer to form an electric cooling device. The method of manufacturing the integrated electrofluidic system may further include applying a chemically functional coating to the substrate. The chemically functional coating may be chosen from the group consisting of polymers, antibodies, human IgG, animal IgG, antibody fragments, antigens, antigen fragments, peptides, aptamers, single-stranded DNA (ssDNA), or other biomolecules.

### BRIEF DESCRIPTION OF THE DRAWINGS

Other objects, features and advantages will occur to those skilled in the art from the following description of a preferred embodiment and the accompanying drawings, in which:

FIG. 1 is a schematic side view of a prior art microsystem employing individual fluidic and electronic components interconnected by microtubules;

FIG. 2A is a schematic side sectional view of the integrated electrofluidic system of the subject invention;

FIG. 2B is a block diagram of the integrated electrofluidic system shown in FIG. 2A;

FIG. 3 is a schematic top view of another example of the integrated electrofluidic system in accordance with this invention;

FIG. 4 is a schematic side view of another embodiment of the integrated electrofluidic system showing an integrated heat exchanger device in accordance with this invention;

FIG. 5 is a schematic side view of another embodiment of the integrated electrofluidic system showing an integrated fuel cell in accordance with this invention;

FIGS. 6A-6L are cross-sectional side views showing the primary steps involved in the method of manufacturing the integrated electrofluidic system in accordance with the present invention;

FIGS. 7A-7D are cross-sectional side views showing the primary steps involved in laminating an additional electronic component into the integrated electrofluidic system in accordance with this invention; and

FIG. 8 is a three-dimensional top view of one example of the various microfluidic components machined into a layer of the platform of the electrofluidic system of this invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

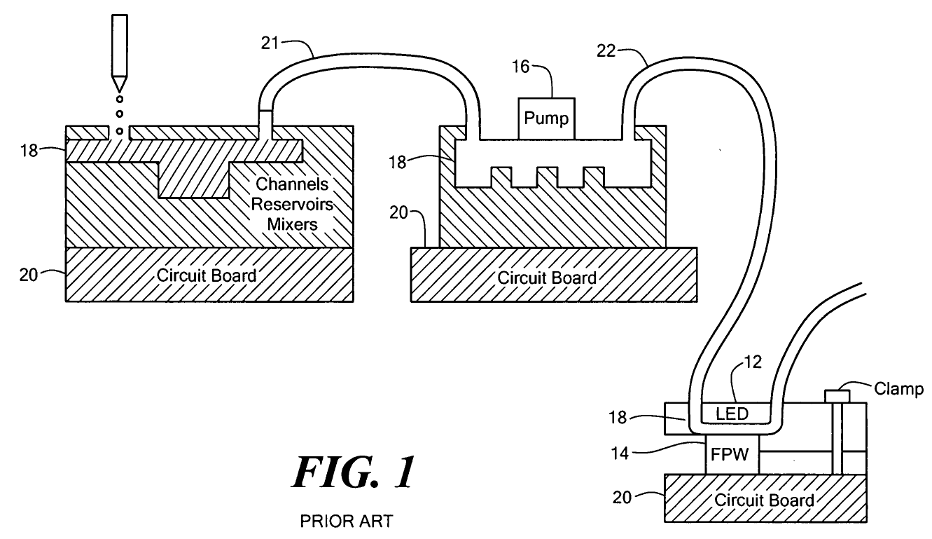

As discussed in the Background section above, conventional microsystem 10, FIG. 1 integrates individual electronic components, such as LED 12 or flexure plate wave device 14 and microfluidic components, such as pump or valve 16 and channels, reservoirs, and mixing devices indicated generally at 18, by assembling the individual electronic components and microfluidic components on common substrate 20 (e.g., a circuit board). Interconnection between the electronic and fluidic components is achieved with an interface, such as microtubules 21 and 22. As also delineated above, conventional microsystem 10 has several distinct drawbacks, including, inter alia multiple placement steps of the various components on substrate 20, the requirement of attaching the components to the surface of substrate 20 by dispensing adhesives employing glass or ceramic materials to achieve precise machining, and utilizing microtubules to interconnect the electronic and microfluidic components, which is complicated, time consuming, unreliable, and expensive. Using microtubules also increases the overall volume of fluid required by the system.

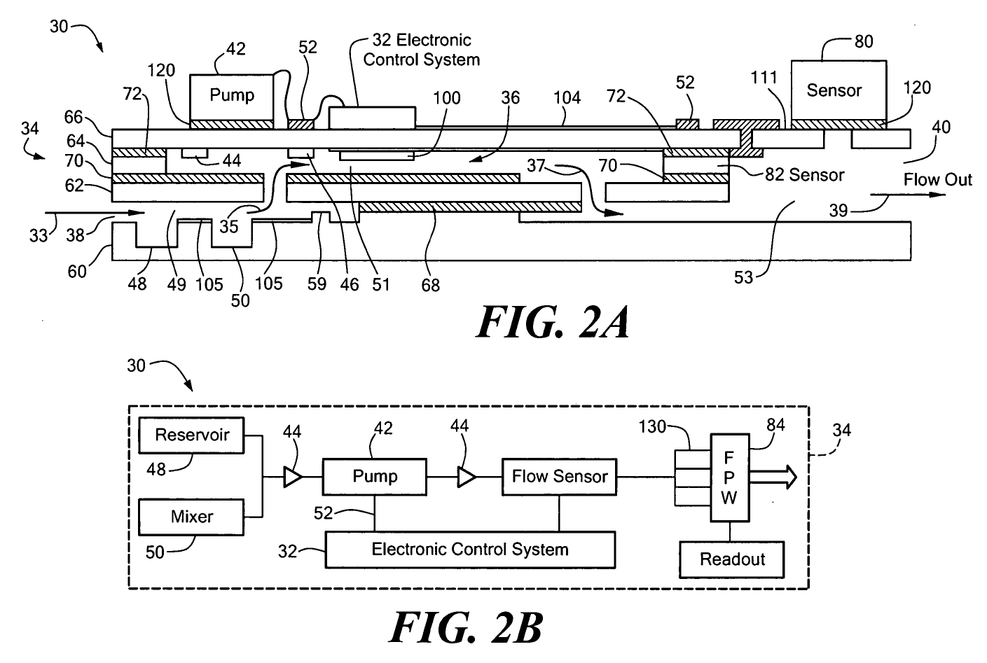

In contrast, integrated electrofluidic system 30, FIGS. 2A and 2B includes electronic control system 32 mounted on support platform 34. System 30 further includes microfluidic system 36 embedded in platform 34 having input 38, output 40, and at least one electrofluidic component, such as pump 42, check valves 44 and 46, channels 49, 51, and 53, reservoir 48, and mixer 50. Other examples of electrofluidic components may include a filter, a dispenser, a reactor, a heater, a concentrator, a pressurizing device, a cooling device, an electrode, a flow sensor, a temperature sensor, a pressure sensor, a chemical sensor, and a biological sensor. Other examples of electrofluidic components will occur to those skilled in the art. Typically, channels 49, 51 and 53 provide a fluidic interconnection between the various electrofluidic components and/or sensors, such as embedded sensor 82. System 30 also includes at least one electrical conductor, such as electrical conductor 52 carried by platform 34 for electrically interconnecting electronic control system 32 and at least one electrofluidic component (e.g., pump 42).

The innovative design of integrated electrofluidic system 30 with embedded microfluidic system 36 having unique embedded channels 49, 51, and 53 which interconnect the various electrofluidic components and/or sensor eliminates the need for microtubules. Eliminating microtubules significantly decreases production cost and improves reliability of integrated electrofluidic system 30. System 30 also requires less fluid volume than conventional microsystems. Moreover, fluid is efficiently circulated over the various surfaces of the electrofluidic components, as indicated by arrows 33, 35, 37 and 39, and sensors, such as embedded sensor 82.

Support platform 34 typically includes a plurality of laminated layers, such as layers 60, 62, 64 and 66 which form embedded microfluidic system 36. In a preferred embodiment, layers 60-66 of platform 34 include a polyimide material, such as commercially available and relatively inexpensive KAPTON® (available from Rogers Corporation, Chandler, Ariz.). Polyimide materials, such as KAPTON®, and similar materials known to those skilled in the art, are polymers which can easily be precisely machined and are relatively less expensive than glass and silicon materials as employed in conventional microsystems. Layers 60, 62, 64 and 66 are typically laminated using a phenolic resin adhesives 68, 70, and 72, respectively. In one example, phenolic resin adhesives 68-72 are R/FLEX® (Rogers Corporation, Chandler, Ariz.). The preferred thickness of the phenolic resin adhesive layer is about 3 to 10 microns. The details of thinning the adhesive to 3 to 10 microns are described below.

Integrated electrofluidic, system 30 may also include a sensor device, such as sensor device 80 connected or integrated with microfluidic system 36. In this example, sensor device 80 is mounted on and electrically interconnected to other components on the surface of platform 34 using standard surface mounting techniques known to those skilled in the art (e.g., utilizing liquid adhesives and soldering techniques).

In other designs of this invention, sensor 80 may be attached to the surface layer 66 of platform 34 with adhesive layer 120. The various microfluidic components of system 30 (e.g., pump 42 and the like) and electronic control unit 32 may be similarly attached to the, surface of platform 34 using phenolic resin adhesive 120, or by utilizing conventional techniques known to those skilled in the art.

In other designs of this invention, system 30 includes a sensor device embedded within platform 34, such as sensor 82 embedded between layers 62 and 66, with phenolic resin adhesives 70 and 72. Adhesive layers 70 and 72 also secure and seal sensor 82 in place. In this design, the need for the complicated step of applying adhesives is eliminated, as is the requirement for multiple placement steps and using microtubules to interconnect the sensors with the various microfluidic components and/or electronic components, resulting in a significant reduction in manufacturing costs. Moreover, the liquid sample size is reduced which improves the performance of system 30.

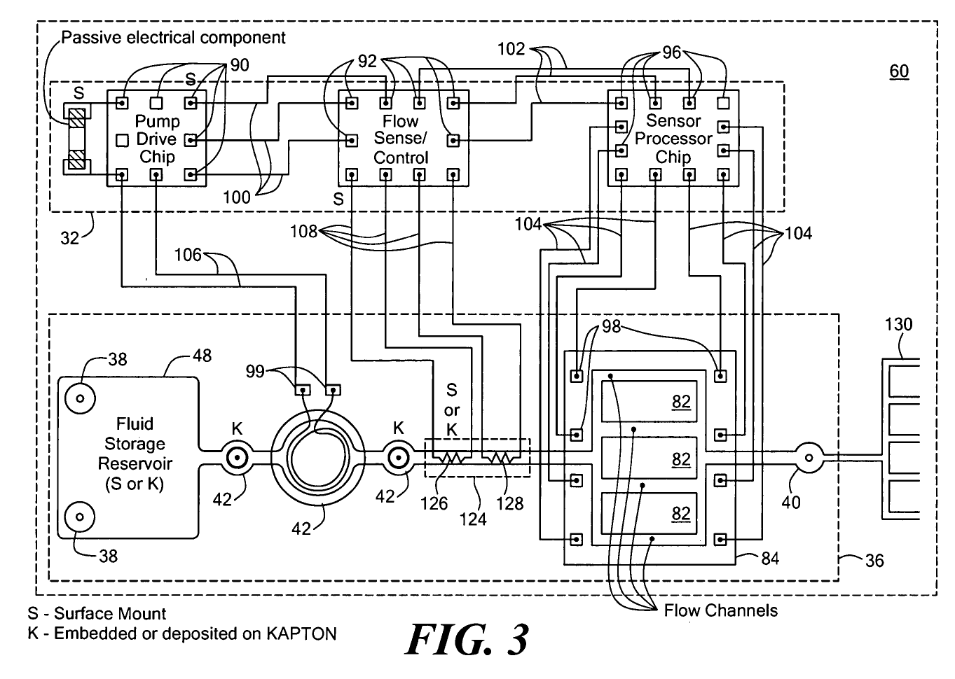

In a preferred embodiment, sensor device 80 or 82 may be a mass sensor device, such as flexure plate wave device 84, FIG. 2B, shown in greater detail in FIG. 3. In other designs, integrated electrofluidic system 30 may include flow sensor 124, FIG. 3 which includes resistive heater 126 and resistive temperature detector (RTD) 128. As fluid flows over resistive heater 126, the fluid transfers heat from resistive heater 126 to RTD 128. This heat transfer creates a change in temperature at RTD 128 which causes a change in resistance of RTD 128 which may be used as a quantitative measure of flow rate.

Sensors 80 and 82, FIG. 2A may also include a photoelectric sensor device, an optical sensor device, an electrochemical sensor device, a temperature sensor device, a pressure sensitive device, a viscosity sensor device, a magnetic sensor device, an acoustic sensor device, or any other suitable device known to those skilled in the art, connected to or integrated with the surface of platform 34 or embedded within system 30 using the techniques described above.

Moreover, as shown in FIG. 3, where like parts have been given like numbers, electrical pads, such as electrical pads 90, 92, 96, and 98, and electrical leads, such as electrical leads 100, 102, 104, 106, and 108 may be formed by fabricating metal conductor traces, such as titanium, gold, and copper, or similar conductive metals known to those skilled in the art (e.g., platinum, nickel, chrome, and tungsten), on or between the various layers, e.g., layers 60-66, FIG. 2A, of system 32 to interconnect the various microfluidic components and/or electronic components. For example, electrical leads 104, FIG. 3 may be fabricated utilizing conventional metal deposition techniques, such as physical vapor deposition (PVD), patterning and etching, which may include evaporation and electroplating, directly on surface 111, FIG. 2A of layer 66 to provide an interconnection between sensor 80 and control system 32. When thick metallization is required, the metal traces described above may be plated with copper-or similar materials to increase the thickness of the leads. In other designs, electrical leads may be embedded within system 30 by depositing the conductive metals on the various layers before the layers are laminated. For example, embedded electrical lead 105 is formed by depositing a conductive metal (e.g., gold, titanium, platinum, nickel, chrome, tungsten, and similar conductive metals) on the surface of layer 60 before layers 60 and 62 are laminated. In this example, electrical lead 105 provides an electrical connection between reservoir 48, mixer 50, and check valve 59. The result is that electrical leads can be embedded within system 30, as well as a reduction in the need to utilize soldering techniques to interconnect surface mounted components, hence further reducing production costs.

In one design, system 30 may include dispensing device 130, FIG. 3 integrated with or connected to microfluidic system 36. Dispensing device 130 may be used for the delivery of drugs, medical diagnostics, tissue engineering, prosthetics, material processing, chemical analysis, environmental sampling, microdispensing, graphic art, or any application where the delivery of a small volume of fluid is required. Dispensing device 130 can deliver small volumes of fluid (e.g., less than 1 ml) at a flow rate of less than 10 ml/min. In one preferred embodiment, the volume of fluid delivered may be 0.5 μl with a flow rate in the range of about 5 μl/min for use in applications such as DNA analysis in a Lab-on-a-Chip.

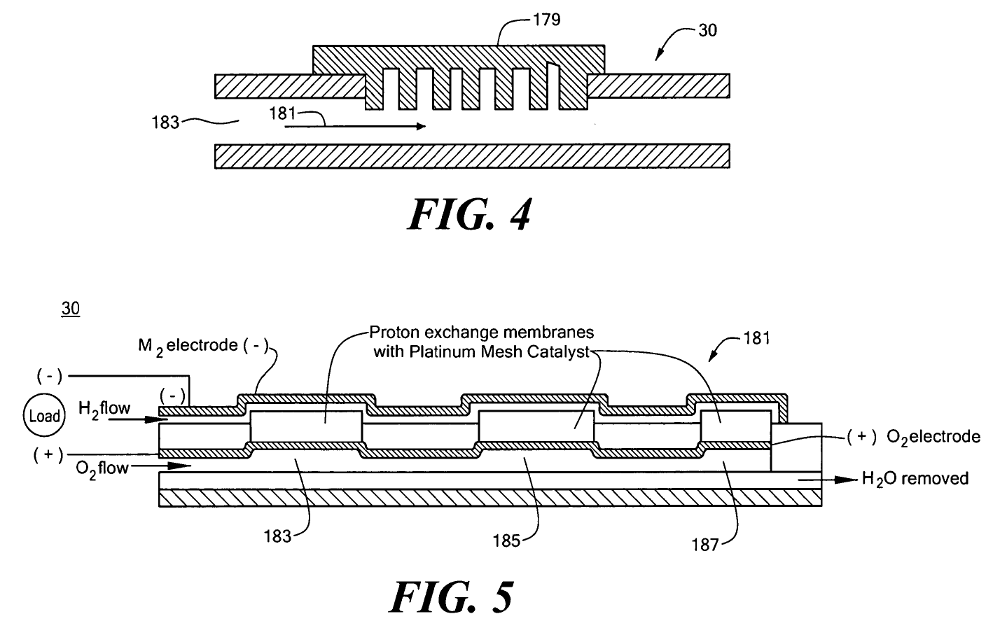

In one design of this invention, integrated electrofluidic system 30 may include an integrated heat exchange device, such as heat exchanger 179, FIG. 4. In other designs, system 30 may include an integrated fuel cell device, such as fuel cell 181, FIG. 5. In this example, fuel cells 183, 185 and 187 are in series with the fluid flow, indicated by arrow 181, within embedded channel 183. In other designs, fuel cells 183-187 may be stacked in parallel.

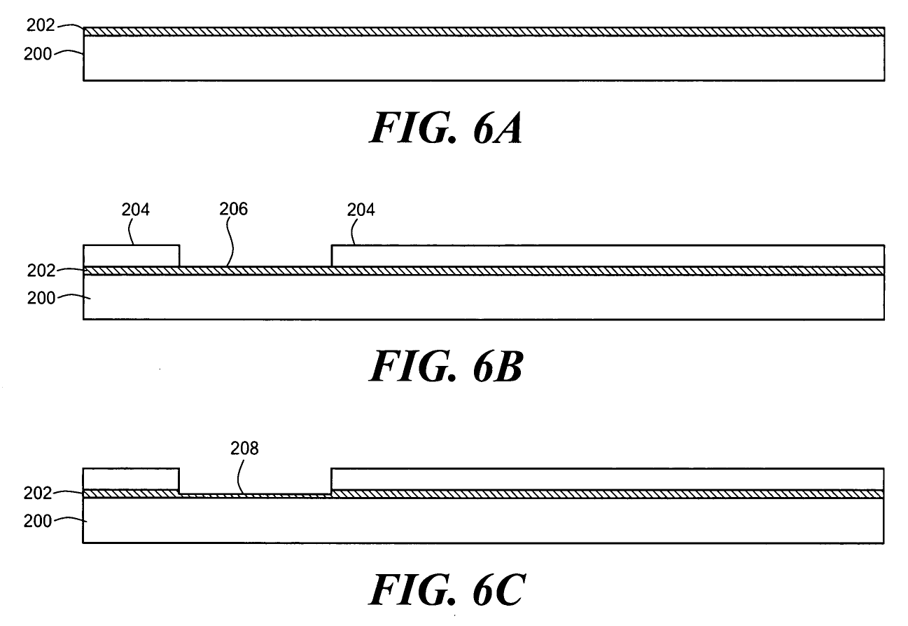

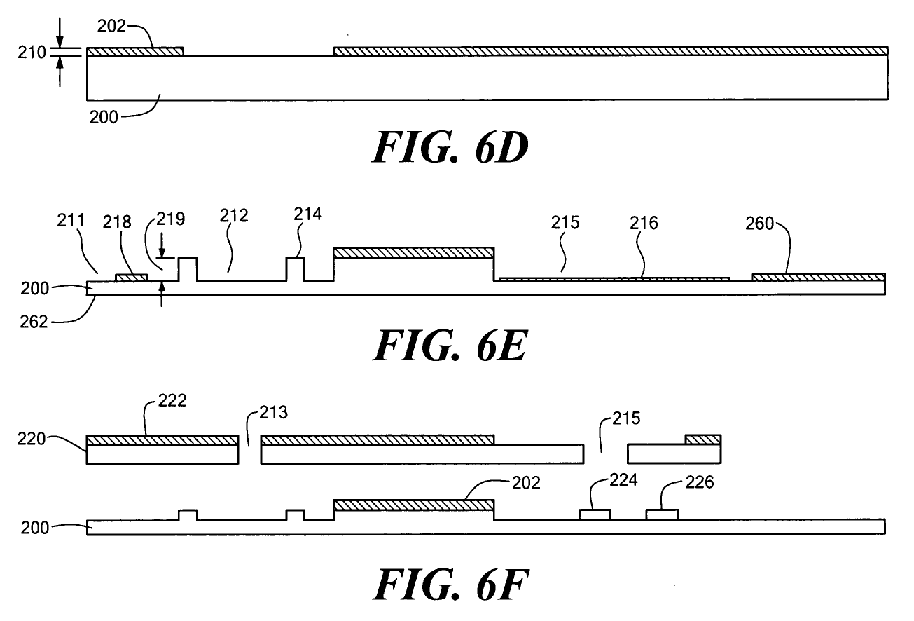

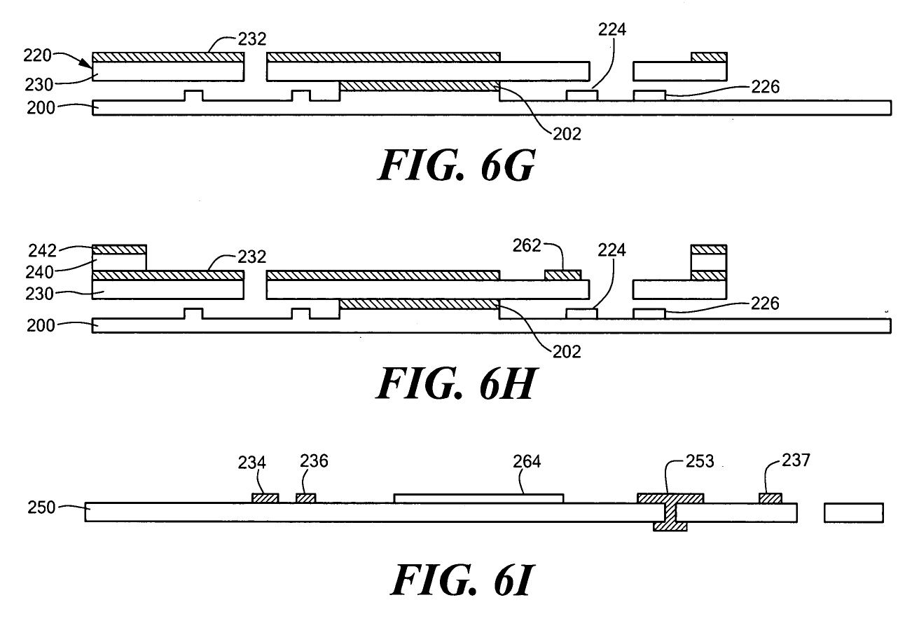

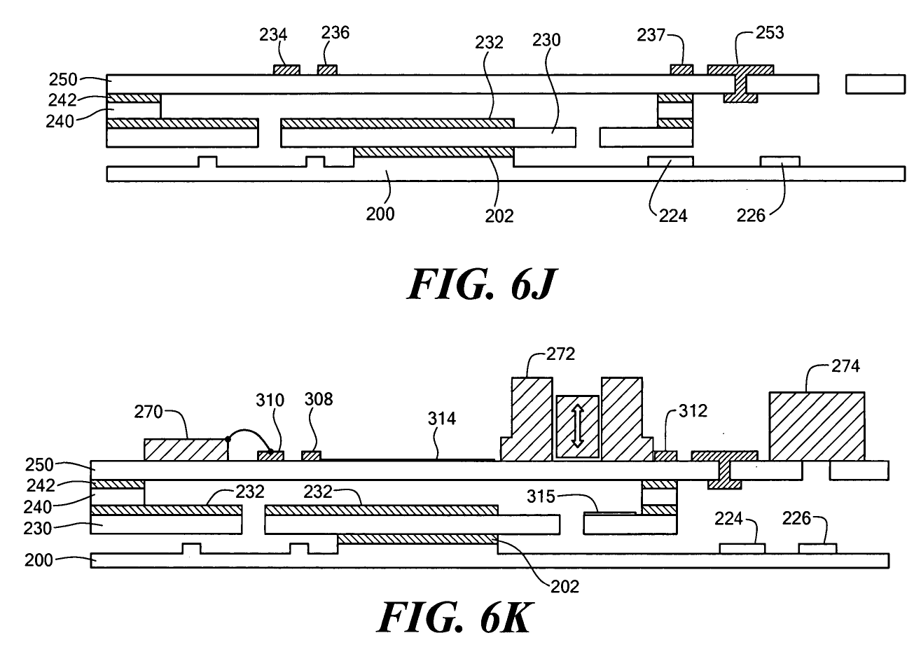

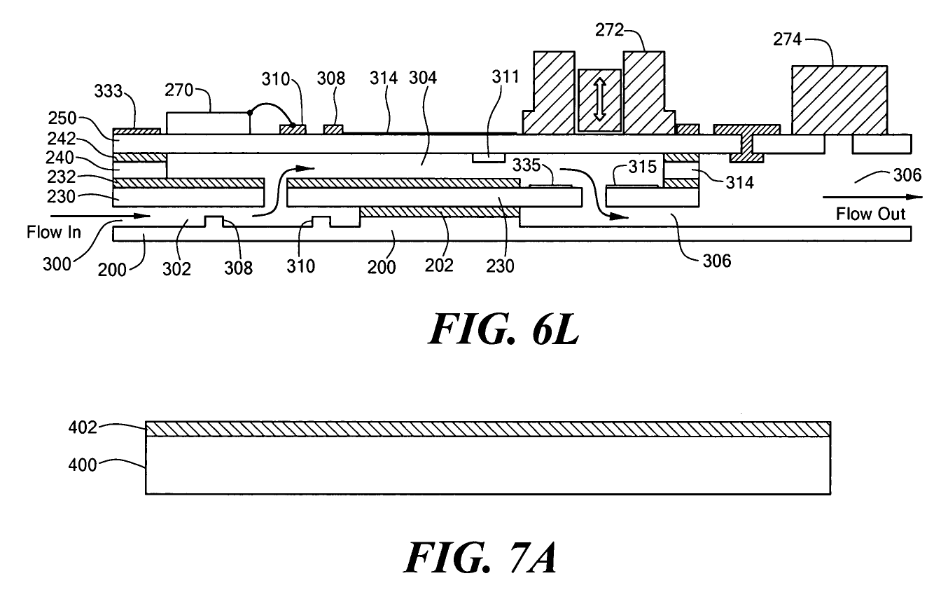

The method for manufacturing the integrated electrofluidic system of this invention includes the steps of: providing substrate layer 200, FIG. 6A, with adhesive layer 202. Substrate layer 202 may be made of KAPTON® and adhesive layer 202 may be a phenolic resin such as R/FLEX® (Rogers Corporation, Chandler, Ariz.). Substrate layer 200 is typically purchased with the KAPTON® layer approximately 125 μm thick with adhesive layer 202 approximately 25 μm thick. In one embodiment, temporary mask 204, FIG. 6B, is applied to adhesive layer 202 for defining removal of specific sections of adhesive 202, such as section 206. Section 206 is thinned, as shown in FIG. 6C, to approximately 10 to 15 μm by plasma etching. In one example, plasma etching of adhesive layer 202 is performed by utilizing a reactive ion etch (RIE) process in oxygen, such as an Oxford/PlasmaTech parallel plate, system (Oxford Instruments, Concord, Mass.). Those skilled in the art will recognize that any plasma etching system may be utilized. Mask or stencil 204 is then removed from layers 200 and 202, as shown in FIG. 6D and adhesive layer 202 is further thinned to a preferred thickness in the range of about 3 to 10 microns thick by similar plasma etching techniques. In a preferred embodiment, adhesive layer 202 is thinned to a 5 μm thickness and adhesive layer 202 is fully removed from section 206.

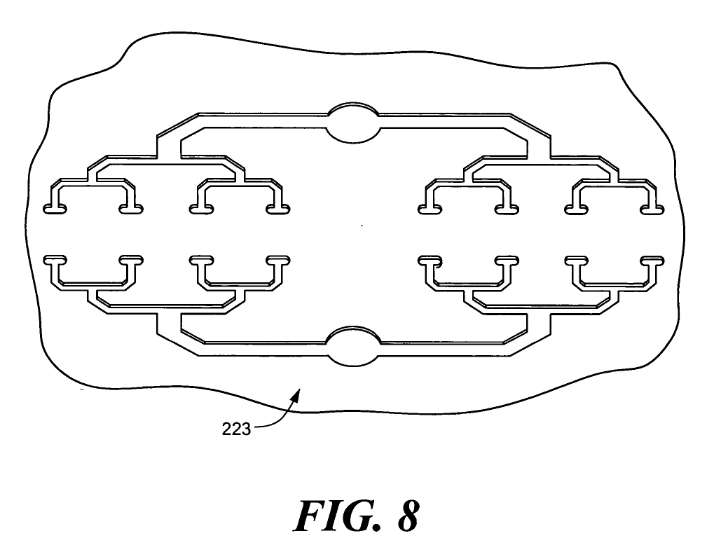

The method of manufacturing the integrated electrofluidic system of this invention also includes the step of machining adhesive layer 202, FIG. 6E, and substrate layer 200 to create features that define at least one microfluidic component and/or at least one electronic component. Machining of layers 200 and 202 is performed by applying an energy beam with a laser scanning system, such as a model 4420 ESI Micro Machining System (ESI, Portland, Oreg.), or other similar laser machining devices known to those skilled in the art. In one example, sections of substrate layer 200 are machined to define any number of microfluidic components such as reservoir 211, mixer 212, valve 214, channel 215, or any of the various microfluidic components discussed above. An example of substrate layer 200 after the various microfluidic components have been machined in accordance with this invention is indicated by arrow 223, FIG. 8. In one example, the machining step includes raster scanning to define the various microfluidic components. In this example, the depth of reservoir 211, FIG. 6E, as indicated by arrow 219, is controlled by modifying the raster path and beam power.

As also discussed above, a thin layer of metal conductive material such as gold, titanium, aluminum, platinum, nickel, chrome, tungsten, or any other suitable conductive metal, may be deposited onto substrate layer 200 and patterned by photo lithography to define electrical leads or pads, such as electrical lead 216 or electronic pad 218, which may be embedded within system 30. In one example, the conductive metals are applied using physical vapr deposition (PVD) techniques (e.g., sputtering) in conjunction with photolithography etching. Those skilled in the art will recognize that any electronic device, such as heating elements, flow sensors, and the like may be machined into or onto substrate layer 200.

Subsequent layers, e.g., second substrate layer 220, FIG. 6F, with adhesive layer 222 are machined and thinned using the techniques, above to define additional microfluidic components (e.g., through holes 213, and 215) and/or additional electronic components. In one example, additional electronic components and/or fluidic components to be embedded within the electrofluidic system may be attached to first substrate layer 200, (e.g., sensor 224 and/or microfluidic device 226) before second layer 220 and first layer 200 are laminated.

Substrate layers 200 and 220, FIG. 6G, are then aligned and laminated together with adhesive layer 202 thereby embedding the microfluidic components and/or electronic components between layers 200 and 220. As needed, additional layers may be added, such as third substrate layer 240, FIG. 6H, with adhesive layer 242. Third layer 240 and adhesive layer 242 may be machined and thinned using the techniques above to define additional microfluidic and/or electronic components on layer 240. Top layer 250, FIG. 6I, is then prepared to include conductors 234, 236, and 237 located on the surface of top layer 250. Additionally, heater device 253 may be embedded within top layer 250. Top layer 250 is typically prepared using standard circuit board technology known to those skilled in the art. Top layer 250, FIG. 61, is then aligned and laminated to layer 240 by adhesive layer 242. Additional surface mount components, such as electronic control unit 270 (e.g., a processing chip), FIG. 6K, pump 272 and sensor 274 may be attached to top surface 250 using conventional surface mounting techniques or by utilizing thin adhesive layer, as described above. Electrical pads 308, 310, and 312 and electrical leads, such as surface electrical lead 314 or embedded lead 315 may be fabricated on the various substrate layers utilizing the techniques described above. An example of a completed integrated electrofluidic system using the method of manufacturing of this invention is shown in FIG. 6L which depicts the unique embedded microfluidic components, such as channels 302, 304 and 306, check valves 308 and 310, flow sensor 311, and unique embedded electronic components, such as sensor 314. Although as shown in FIG. 6L, there are four predetermined substrate layers with three of the substrate layers having an adhesive layer (e.g., substrate layers 200, 230 and 240 with adhesive layers 202, 232, and 242, respectively), this is not a necessary limitation of this invention, as any number of substrate layers and adhesive layers may be used by those skilled in the art. In a preferred embodiment, the substrate layers (e.g., substrate layers 200, 230, 240, and 250) include KAPTON® and the adhesive layers. (e.g., adhesive layers 202, 230, 240 and 242) include R/FLEX®.

The method of manufacturing integrated electrofluidic system 30 may also include the step of removing residual carbon and cleaning the substrate layers. Additionally, adhesive layers 202, 232, and 242, FIG. 6L, may be tacked to assist in securing the various components to substrate layers 260, 230, 240 and 250. Tacking consists of utilizing partially cured adhesives (e.g., adhesive layers 202, 232, and 242) and applying and positioning the various components on the various layers (e.g., layers 200, 230, 240 and 250). Tacking provides the ability to precisely locate the components before a final cure is performed, hence eliminating the need for multiple placement steps.

A chemically functional coating may be applied to any of the various substrate layers such as chemically functional coating 333 on surface of layer 250 or chemically functional coating 335 located on embedded layer 230. Chemically functional coating 333 and chemically functional coating 335 may be comprised of polymers, antibodies, such as human or animal IgG, antibody fragments, peptides, aptamers, single-stranded DNA (ssDNA), or other molecular recognition coatings known to those skilled in the art.

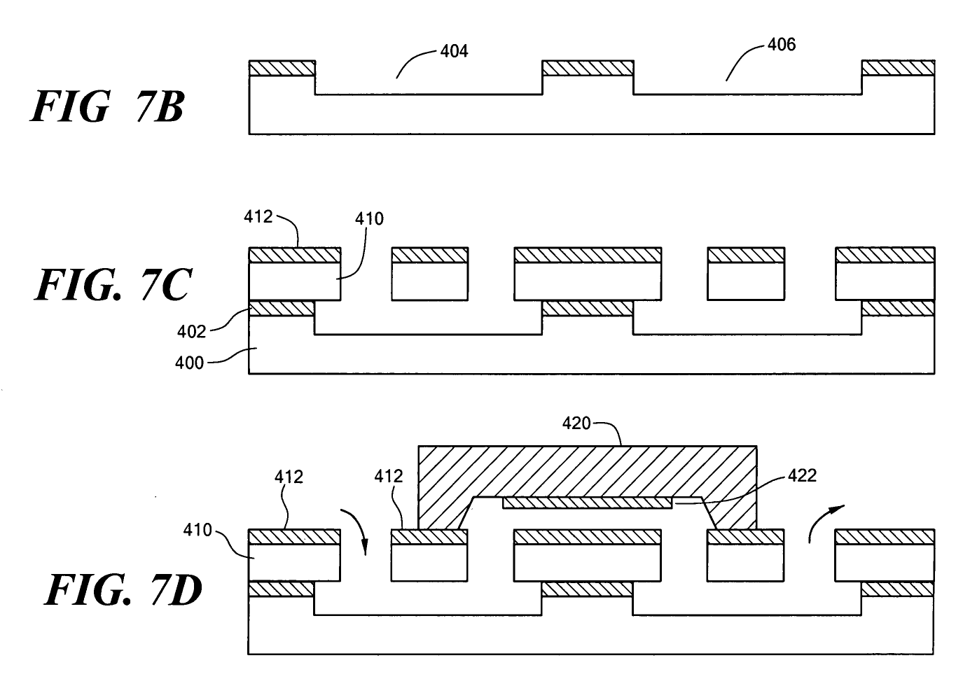

An example of manufacturing the integrated electrofluidic system of this invention to embed an electronic component within the electrofluidic system is shown in FIGS. 7A-7D. In this example, substrate layer 460, FIG. 7A, with adhesive layer 402 is provided as described above. Various microfluidic components and/or electronic components are then machined as shown in FIG. 7B, such as channels 404 and 406, similarly using the techniques described above. The process is repeated, as described above, and additional layers, such as layer 410 with adhesive layer 412 are provided and laminated as shown in FIG. 7C. Sensor 420, FIG. 7D, is then laminated to layer 410, FIG. 7D, utilizing adhesive 412. In one example, sensor 420 is a flexure plate wave device and may also include a chemically functional coating 422. A unique feature of attaching sensor 420 to substrate layer 410 via adhesive 412 is that sensor 420 is laminated and sealed quickly and easily, instead of using conventional gluing and liquid adhesive methods, and hence significantly decreases production costs.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. An integrated electrofluidic system comprising:
an electronic control system mounted on a support platform;
a microfluidic system embedded in said platform and having an input and an output and at least one electrofluidic component; and
at least one electrical conductor carried by said platform for electrically interconnecting said electronic control system and said at least one electrofluidic component.

2. The integrated electrofluidic system of claim 1 in which said platform includes a plurality of laminated layers forming said embedded microfluidic system.

3. The integrated electrofluidic system of claim 1 in which said platform includes a polyimide material.

4. The integrated electrofluidic system of claim 1 in which said platform includes KAPTON®.

5. The integrated electrofluidic system of claim 2 in which said layers ate laminated using a phenolic resin adhesive.

6. The integrated electrofluidic system of claim 5 in which said phenolic resin adhesive is R/FLEX®.

7. The integrated electrofluidic system of claim 5 in which said phenolic resin adhesive is etched to a thickness of 3 to 10 μm.

8. The integrated electrofluidic system of claim 5 in which said phenolic resin adhesive is selectively removed from regions where bonding is undesirable between said layers and/or between a said layer and said electrofluidic component and/or a microfluidic component.

9. The integrated electrofluidic system of claim 1 in which said microfluidic system includes a valve.

10. The integrated electrofluidic system of claim 1 in which said micro fluidic system includes a pump.

11. The integrated electrofluidic system of claim 1 in which said microfluidic system includes a reservoir.

12. The integrated electrofluidic system of claim 1 in which said microfluidic system includes a mixer.

13. The integrated electrofluidic system of claim 1 in which said microfluidic system includes at least one channel.

14. The integrated electrofluidic system of claim 1 in which said microfluidic system includes a filter.

15. The integrated electrofluidic system of claim 1 in which said microfluidic system includes a dispenser.

16. The integrated electrofluidic system of claim 1 in which said microfluidic system includes a reactor.

17. The integrated electrofluidic system of claim 1 in which said microfluidic system includes a heater.

18. The integrated electrofluidic system of claim 1 in which said microfluidic system includes a concentrator.

19. The integrated electrofluidic system of claim 1 in which said microfluidic system includes a pressurizing device.

20. The integrated electrofluidic system of claim 1 in which said microfluidic system includes a cooling device.

21. The integrated electrofluidic system of claim 1 further including a sensor device integrated with said microfluidic system.

22. The integrated electrofluidic system of claim 21 in which said sensor device is embedded in said platform.

23. The integrated electrofluidic system of claim 21 in which said sensor device includes a flexure plate wave sensor.

24. The integrated electrofluidic system of claim 21 in which said sensor device includes a photoelectric sensor device.

25. The integrated electrofluidic system of claim 21 in which said sensor device includes an optical sensor device.

26. The integrated electrofluidic system of claim 21 in which said sensor device includes an electrochemical sensor device.

27. The integrated electrofluidic system of claim 21 in which said sensor device includes a temperature sensor device.

28. The integrated electrofluidic system of claim 21 in which said sensor device includes a pressure sensor device.

29. The integrated electrofluidic system of claim 21 in which said sensor device includes a flow sensor device.

30. The integrated electrofluidic system of claim 21 in which said sensor device includes a viscosity sensor device.

31. The integrated electrofluidic system of claim 21 in which said sensor device includes a mass sensor device.

32. The integrated electrofluidic system of claim 21 in which said sensor device includes a magnetic sensor device.

33. The integrated electrofluidic system of claim 21 in which said sensor device includes an acoustic sensor device.

34. The integrated electrofluidic system of claim 1 further including a dispenser device integrated with said microfluidic system.

35. The integrated electrofluidic system of claim 1 further including a heat exchange device integrated with said microfluidic system.

36. The integrated electrofluidic system of claim 34 in which said dispenser device includes a drug delivery device.

37. The integrated electrofluidic system of claim 1 further including a fuel cell device integrated with said microfluidic device.

38. An integrated electrofluidic system comprising:
an electronic control system mounted on a support platform;
a microfluidic system embedded in said platform and having an input and an output and at least one electrofluidic component;
at least one electrical conductor carried by said platform for electrically interconnecting said electronic, control system and said at least one electrofluidic component; and
a sensor integrated with said electrofluidic system.

39. The integrated electrofluidic system of claim 38, in which said platform includes a plurality of laminated layers forming said embedded microfluidic system.

40. An integrated electrofluidic system comprising:
an electronic control system mounted on a support platform;
a microfluidic system embedded in said platform and having an input and an output and at least one electrofluidic component;
at least one electrical conductor carried by said platform for electrically interconnecting said electronic control system and said at least one electrofluidic component; and
a dispenser device integrated said electrofluidic system.

41. The integrated electrofluidic system of claim 40 in which said platform includes a plurality of laminated layers forming said embedded microfluidic system.

42. The integrated electrofluidic system of claim 40 in which said dispensing, device dispenses fluid in the range of about 100 microliters to 100 picoliters.

43. The integrated electrofluidic system of claim 40 in which said dispensing device dispenses fluid at a rate of about 0.1 to 100 microliters/min.

44. An integrated electrofluidic system comprising:
an electronic control system mounted on a support platform;
a microfluidic system embedded in said platform and having an input and an output and at least one electrofluidic component;
at least one electrical conductor carried by said platform for electrically interconnecting said electronic control system and said at least one electrofluidic component; and
a heat exchange device integrated with said electrofluidic system.

45. The integrated electrofluidic system of claim 43 in which said platform includes a plurality of laminated layers forming said embedded microfluidic system.

46. A method for manufacturing an integrated electrofluidic system, the method comprising:
a) providing a substrate layer having an adhesive layer;
b) thinning said adhesive layer;
c) machining said adhesive layer and said substrate layer to create features that define at least one microfluidic component and/or at least one electronic component;
d) aligning said substrate layers;
e) laminating the layers to embed said microfluidic component and/or said electronic component between said layers; and
f) repeating steps a) through e) for a predetermined number of layers of said substrate and said adhesive layer.

47. The method of claim 46 in which said substrate layer is KAPTON®.

48. The method of claim 46 in which said adhesive layer is thinned by plasma etching.

49. The method of claim 46 in which said adhesive layer and said substrate are machined by applying an energy beam with a laser.

50. The method of claim 46 in which step a) further includes providing additional microfluidic component and/or an electronic component to be embedded between said layers.

51. The method of claim 46 further including the step of attaching additional microfluidic components and/or electronic components to the top surface of said laminated layers.

52. The method of claim 46 further including the step of applying a mask to said adhesive layer to define removal of said adhesive and to further define said microfluidic components.

53. The method of claim 46 in which step a) further includes providing electrical pads and electrical leads for interconnecting said microfluidic components and said electronic components.

54. The method of claim 46 further including the step of attaching electrical pads and electrical leads to the surface of said laminated layers.

55. The method of claim 49 in which said machining includes raster scanning to define said features.

56. The method of claim 55 further including the step of controlling the depth of said features by modifying said raster path.

57. The method of claim 46 further, including the step of removing residual carbon and cleaning said substrate layers.

58. The method of claim 46 further including the step of tacking the layers.

59. The method of claim 46 wherein said machining includes depositing and patterning thin films of material on said substrate layer to form said electronic components.

60. The method of claim 59 in which said material is chosen from the group consisting of titanium, chrome, gold, platinum, tungsten, copper and nickel.

61. The method of claim 59 in which said material is plated with a material including copper.

62. The method of claim 60 further including the step of depositing a thin film of said material on said substrate layer to form an electric heater.

63. The method of claim 62 further including the step of depositing a thin film of said material on said substrate layer to form an electric cooling device.

64. The method of claim 46 in which step c) further includes applying a chemically functional coating to said substrate.

65. The method of claim 64 in which said chemically functional coating is chosen from the group consisting of: polymers, antibodies, human IgG or animal IgG, antibody fragments, antigens, antigen fragments, peptides, aptamers, single-stranded DNA (ssDNA), and biomolecules.
